(19) United States
(12) Patent Application Publication
(10) Pub. No.: US 2016/0294191 A1
(43) Pub. Date: Oct. 6, 2016

(54) PHOTOVOLTAIC-BASED FULLY INTEGRATED PORTABLE POWER MANAGEMENT AND NETWORKING SYSTEM

(71) Applicant: Ascent Solar Technologies, Inc., Thornton, CO (US)

(72) Inventors: Joseph H. Armstrong, Littleton, CO (US); Inbo Lee, Broomfield, CO (US); Stephanie Persha Retureta, Highlands Ranch, CO (US)

(21) Appl. No.: 15/089,028

(22) Filed: Apr. 1, 2016

Related U.S. Application Data
(60) Provisional application No. 62/142,795, filed on Apr. 3, 2015.

(51) Int. Cl. H02J 3/38; H02S 40/38; H02S 30/20; H02M 7/44; H02J 7/35; H02S 40/32; H02J 9/06

(52) U.S. Cl. CPC H02J 3/383; H02S 40/32; H02S 40/38; H02J 9/061; H02M 7/44; H02J 7/35; H02S 30/20

(57) ABSTRACT

A photovoltaic-based fully integrated portable power management and networking system includes a flexible photovoltaic module and an integrated power management, storage, and distribution and networking (MSDN) subsystem. The flexible photovoltaic module is capable of being disposed in at least a folded position and an unfolded position, and the MSDN subsystem is mechanically and electrically coupled to the flexible photovoltaic module. The MSDN subsystem includes an integrated networking subsystem for providing Internet connection to one or more devices, and the integrated networking subsystem is at least partially powered from the flexible photovoltaic module.

### RELATED APPLICATIONS

This application claims benefit of priority to U.S. Provisional Patent Application Ser. No. 62/142,795, filed Apr. 3, 2015, which is incorporated herein by reference in its entirety.

### BACKGROUND

Photovoltaic (PV) power systems have been widely used for generating electrical power from sunlight. Most often, these systems have consisted of heavy, rigid glass PV panels that generate direct current (DC), and a balance of systems (BOS) that may consist of a combination of power management circuitry, battery storage with charge control circuitry, and possibly an inverter that converts the DC power to alternating current (AC) to operate household components.

One advantage of such systems is that they do not necessarily require connection to an existing power grid, and as such, can provide power in remote locations. However, while portable versions of these systems exist, the rigid nature of the PV panels in order to protect the fragile crystalline solar cells, as well as the significant weight of sealed lead acid (SLA) batteries commonly used therein, prohibit their wide spread use.

Lightweight and flexible PV modules, frequently referred to as photovoltaic blankets or PV blankets, have been developed as an alternative to rigid glass PV panels. PV blankets are commercially available and are sufficiently light to allow for portable power generation. Conventional portable power systems including PV blankets suffer from a number of significant disadvantages, however. For example, it can be difficult to find a PV blanket that is compatible with a given BOS, or vice versa, because PV blankets and BOS are often manufactured by different vendors and designed according to different specifications.

Additionally, conventional portable PV power systems require a plurality of discrete components, i.e., components separate from the PV blanket, which are electrically coupled to the PV blanket and/or each other via cables. This collection of discrete components and interconnecting cables may undesirably clutter an area where the portable PV power system is deployed. The requirement that the discrete components be interconnected via cables may also make system assembly difficult, particularly for an untrained user. Furthermore, the discrete components and/or interconnecting cables may be misplaced, and in some cases, the discrete components are fragile and therefore prone to physical damage. The interconnecting cables may also present a tripping hazard. Thus, additional functionality utilizing the portable system for requisite electrical power further complicates the installation.

Moreover, conventional portable PV power systems will typically not operate at their maximum power point, especially when operated by a person who is not an expert in PV systems. To help appreciate this point, consider the electrical characteristics of PV devices.

Power output of a photovoltaic device, such as a single PV cell or a PV module including a plurality of PV cells, is described as DC, but the values are dynamic, and voltage and current depend heavily on the electrical load imparted upon the photovoltaic device. At zero load, or open circuit, the PV device generates no current and presents its highest voltage, commonly referred to as open-circuit voltage (V_{OC}). As the electrical load attached to the PV device increases, its voltage will remain relatively stable until reaching a point where the voltage will continue to decrease with increasing load (i.e., increasing electrical current). When the photovoltaic device is electrically shorted, the voltage across the device is zero, and the current is referred to as the short-circuit current (or I_{sc}).

Electrical power (P) is calculated by the product of the voltage and current. Where the voltage is relatively stable as current (load) increases, the amount of electrical power generated also increases. As the voltage begins to drop with increasing current (load), the power generated decreases. At the point where peak power output is achieved, commonly referred to as the maximum power point, the voltage and current is commonly referred to as Vₘₐₓ and Iₘₐₓ, respectively.

For example, FIG. 1 illustrates a dynamic response 100 of an exemplary PV device, such as a PV cell or a module of a plurality of PV cells, at 100% light intensity and at 70% light intensity. As illustrated, at 100% light intensity, the PV device will generate a V_{oc} 102 at no load. If the PV device is electrically shorted (e.g. both leads are connected together), there is no voltage across the device, and I_{sc} 104 flows through the photovoltaic device at 100% light intensity. Further, at 100% light intensity, the PV device has a maximum power point 106 with Iₘₐₓ and Vₘₐₓ (not numbered).

However, performance of the PV device is significantly different if less light impinges upon the front surface. For example, both V_{oc} and I_{sc} shift noticeably lower to V_{oc} 108 and I_{sc} 110, respectively, at 70% light intensity. Consequentially, the maximum power point 112 at 70% light intensity is lower and occurs at a lower output voltage than maximum power point 106 at 100% light intensity. Thus, if electronics attached to the PV device are designed to run at a fixed voltage corresponding to maximum power point 106, the PV device will not operate at its maximum power point at 70% light intensity, because the operating voltage will not correspond to the maximum power point at 70% light intensity.

Additionally, environmental conditions affect the maximum power available, as well as the voltage and current at these peak conditions. These environmental conditions may include but are not limited to, the angle of sunlight impinging the PV device, the ambient temperature at the device's location, the increasing temperature of the PV device as the sunlight impinges upon it, the interference of sunlight reaching the PV device due to smoke, fog, dust and dirt, precipitation, leaves, grass, and other naturally occurring phenomenon. Given that the very nature of portable power systems dictates that they may not be ideally inclined towards the sun, operating under ideal temperature conditions, or be free of environmental contaminants blocking sunlight, the PV devices likely will not operate at their maximum performance levels as measured under standard test conditions.

Any circuitry that is intended to connect to a PV device will ideally cause the PV device to operate at a voltage and current corresponding to the PV device's maximum power point. However, as stated above, the maximum power point can change for a variety of reasons, and as such, a means for adjusting the load that the photovoltaic device experiences must be constantly adjusted to maximize its performance. Furthermore, there is no guarantee that this voltage/current corresponding to maximum power point has any relation to what the attached load may require.

Accordingly, conventional portable power systems will typically not operate at their maximum possible level for a number of reasons. Additionally, as the voltage and current at maximum power point may vary under various conditions, PV blankets must be installed and operated by someone who understands how they operate, otherwise they will likely not obtain high performance. For someone who wants to operate a portable PV system, but is not an expert in portable PV systems, clearly this is a disadvantage. Thus, there is a need to provide a portable power system that manages the complexity of a photovoltaic charging solution, advanced battery storage, and requisite power output voltage and current makeup for the user who does not have the time or technical background to manage them his/herself.

### SUMMARY

Applicant has determined that a portable PV power system would provide the ideal platform for various electronic-based functions. One such function would be the operation and management of a wireless networking function, as well as the ability to provide wireless access to the Internet via cellular or satellite connectivity. Such a system would benefit from a clean, regulated power supply that is a fundamental part of the described portable PV power system.

Accordingly, Applicant has developed photovoltaic-based fully integrated portable power systems that may at least partially overcome one or more the problems discussed above, as well as provide a means for remote Ethernet connections for multiple users via cellular-based Internet equipment, or future satellite-based Internet connections. These fully integrated portable networking solutions advantageously include both BOS and PV devices co-packaged in a single assembly, thereby potentially eliminating the need for multiple discrete components and associated interconnecting cables. Additionally, the BOS include maximum power point tracking (MPPT) circuitry which, as discussed below, is capable of causing the photovoltaic devices to operate substantially at their maximum point without user intervention, thereby potentially allowing the portable power systems to achieve high performance, even when used by a person who is not an expert in portable PV systems. Additional functionality is integrated to the system as desired, with the BOS providing the necessary power to operate for significant time. In this embodiment the added functionality is a cellular-based Internet connection with both wired and wireless Internet connectivity.

The BOS additionally include an energy storage subsystem, such as a battery subsystem and associated charge controlling circuitry, to provide stable power, even during temporary shading. In certain embodiments, the battery subsystem includes lithium-ion (Li-Ion) and/or lithium-polymer (LiPo) batteries to promote lightweight, robust, powerful, and stable energy storage, which is particularly well-suited for outdoor portable power applications. Furthermore, in some embodiments, MPPT circuitry also provides both battery charge management and load protection, such as overcurrent protection.

The BOS further include power conversion circuitry for providing one or more regulated power outputs. Some embodiments include a 5 VDC regulated output voltage rail for universal serial bus (USB) charging, and/or a higher power regulated output voltage rail at voltages ranging from 6 VDC up to 48 VDC. Certain embodiments also include an inverter to convert DC from an internal bus voltage rail to AC, such as to operate household equipment.

Some embodiments are also suitable for use outdoors. In these embodiments, the PV module is designed to prevent water and water vapor ingress to protect its long-term operation. Additionally, a case is provided for the electronics, both power and network related, and battery system that prevents water ingress, and all connectors, fuses, and switchgear are designed to prevent water ingress as well. Electronics are potted or a conformal coating is applied after assembly to further protect them from moisture ingress.

In one embodiment, a photovoltaic-based fully integrated portable power system includes (1) an integrated power management, storage, and distribution and networking (MSDN) subsystem including a case having an opening, (2) a flexible photovoltaic module capable of being disposed in at least a folded position and an unfolded position, where a portion of the flexible photovoltaic module is disposed over the opening of the case, and (3) a mounting plate disposed on the flexible photovoltaic module and over the opening of the case, such that the portion of the flexible photovoltaic module is sandwiched between the MSDN subsystem and the mounting plate. The networking function can be cellular based Internet connectivity with both wired and wireless Ethernet router, and the networking function utilizes the power available from the power subsystems of the MSDN and is integrated into the same case.

In another embodiment, a photovoltaic-based fully integrated portable power management and networking system includes a flexible photovoltaic module and an integrated power management, storage, and distribution and networking (MSDN) subsystem. The flexible photovoltaic module is capable of being disposed in at least a folded position and an unfolded position, and the MSDN subsystem is mechanically and electrically coupled to the flexible photovoltaic module. The MSDN subsystem includes an integrated networking subsystem for providing Internet connection to one or more devices, and the integrated networking subsystem is at least partially powered from the flexible photovoltaic module.

### BRIEF DESCRIPTION OF THE DRAWINGS

FIG. 1 illustrates the relationship between voltage and current of an exemplary photovoltaic device, along with the corresponding power output as a function of electrical load (current).

FIG. 2 is a block diagram of a photovoltaic-based fully integrated portable power management system with an integrated Internet connection with both wireless and wired Ethernet connection, according to an embodiment.

FIG. 3 is a top plan view of an integrated power management, storage, and distribution, and networking subsystem according to an embodiment.

FIGS. 4-7 are each different perspective views of a photovoltaic-based fully integrated portable power system with networking, according to an embodiment.

### DETAILED DESCRIPTION

It is noted that, for purposes of illustrative clarity, certain elements in the drawings may not be drawn to scale. Specific instances of an item may be referred to by use of a numeral in parentheses (e.g., USB connector 316(1)) while numerals without parentheses refer to any such item (e.g., USB connectors 316). In the present disclosure, “cm” refers to centimeters, “m” refers to meters, “A” refers to amperes, “mA” refers to milliamperes, and “V” refers to volts.

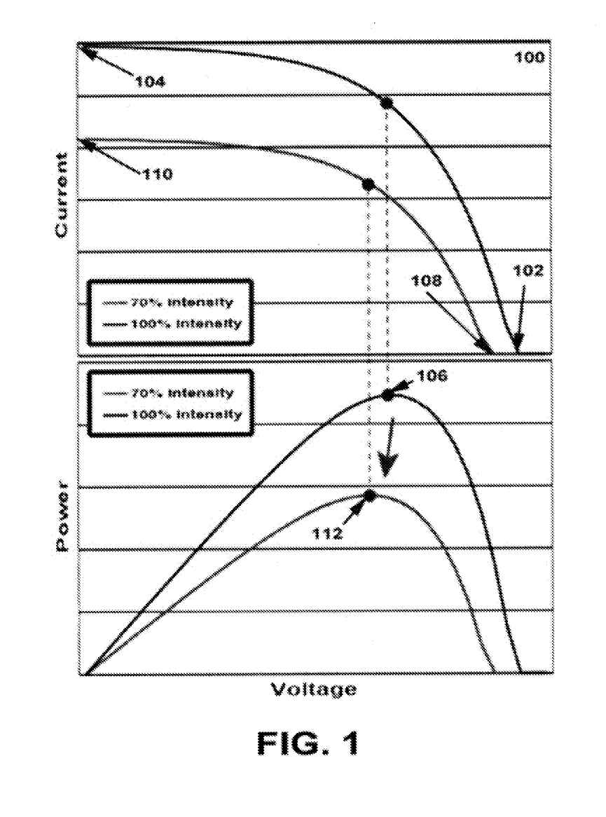

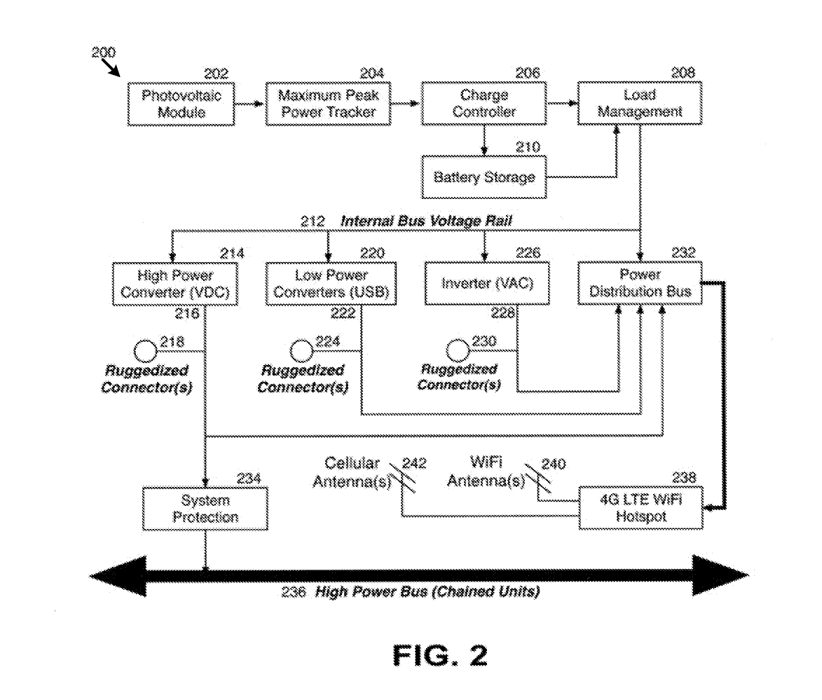

As discussed above, the PV-based fully integrated portable power management and networking systems developed by Applicant include maximum power point tracking (MPPT) circuitry. The MPPT circuitry 204 (see FIG. 2) is designed to adjust the voltage/current position along the power curve to determine the position of the maximum power point. This can be achieved by scanning the load that the PV device ‘sees’, and as the scan proceeds, the MPPT circuitry 204 identifies the position of the maximum power point and maintains PV device operation at this voltage point and current point. Thus, the MPPT circuitry 204 does not need to know the conditions that the PV device is actually experiencing; rather, the MPPT circuitry 204 will adjust its input impedance, thereby adjusting the load condition that the PV device is ‘seeing’, to identify and lock into the maximum power point. For example, if a PV device has characteristics like that illustrated in FIG. 1, the MPPT circuitry 204 will adjust its input impedance such that the PV device operates at maximum power point 106 or 112 at 100% and 70% light intensity, respectively. By effectively decoupling the actual load that the PV device ‘sees’ from the PV device operation, the MPPT circuitry 204 can continuously adjust the effective PV load to ensure the PV device can operate at maximum efficiency.

In order to decouple these functions effectively, it is necessary that the portable PV power system 200: (1) includes a battery storage subsystem that provides the bulk of the electrical power to a load, (2) provides power for charging the battery subsystem, and (3) is capable of simultaneously providing power from the photovoltaic device and battery subsystem to the load. FIG. 2 is a block diagram of a photovoltaic-based fully integrated portable power management and networking system 200 that not only encompasses all of the functions noted above, but also is capable of forming a lightweight, compact system.

The portable power system 200 includes a flexible PV module 202, maximum power point tracking circuitry 204, charge control circuitry 206, load management circuitry 208, a battery subsystem 210, high-power conversion circuitry 214 with ruggedized connector(s) 218, low-power conversion circuitry 220 with ruggedized connector(s) 224, an inverter 226 with ruggedized connector(s) 230, a distribution bus 232, and protection circuitry 234 that feeds a chainable high-power bus 236. As further discussed below, maximum power point tracking circuitry 204, charge control circuitry 206, load management circuitry 208, battery subsystem 210, high-power conversion circuitry 214, low-power conversion circuitry 220, inverter 226, a networking system consisting of both a wireless Internet connection (cellular, satellite, or other means) with both wireless 242 and wired Ethernet (not numbered), protection circuitry 234 and high-power bus 236 are co-packaged, possibly along with additional components, in an integrated power management, storage, and distribution and networking (MSDN) subsystem. Ruggedized connectors 218, 224 and 230 are typically resistant to moisture ingress and form a seal with the MSDN case to protect all internal circuitry. External interfaces to an integrated networking solution 238, sometimes referred to herein as integrated networking subsystem 238, include at least one antenna. In the present embodiment, the external interfaces to the integrated networking solution 238 include at least one wireless Ethernet antenna 240 and cellular antenna 242. Integrated networking solution 238 provides Internet connection to one or more devices. The antennas may be of any type or design, such as a patch type of antenna, to accomplish transmission/reception at the desired frequency. Note that the antennas may be discrete and mounted to the case, or may be other form factors that are integrated into the PV module 202 or elsewhere within the system 200.

The flexible PV module 202 includes a plurality of PV cells (not numbered/shown) for converting light, such as sunlight, into electricity. The PV cells are electrically coupled in series and/or in parallel, to obtain a desired output voltage and output current capability. In some embodiments, the flexible PV module 202 includes a plurality of electrically interconnected flexible PV submodules (not shown/not numbered) monolithically integrated onto a common flexible substrate. Each PV submodule, in turn, includes a plurality of electrically interconnected flexible thin-film PV cells monolithically integrated onto the flexible substrate. The PV cells of the flexible PV module 202 include, for example, copper-indium-gallium-selenide (CIGS) PV cells, copper-indium-gallium-sulfur-selenide (CIGSSe) PV cells, copper zinc tin sulfide (CZTS) PV cells, cadmium-telluride (CdTe) PV cells, silicon (Si) PV cells, and/or amorphous silicon (a-Si) PV cells. In some other embodiments, the PV cells of the flexible PV module 202 include flexible crystalline PV cells, such as thin crystalline silicon (Si) photovoltaic cells or thin gallium arsenide (GaAs) photovoltaic cells. The flexible crystalline PV cells are, for example, fabricated by epitaxial lift-off (ELO) or by mechanical thinning of crystalline wafers, in these embodiments. It is to be understood the flexible crystalline PV cells can be fabricated by other means.

Flexible photovoltaic module 202 is electrically coupled to the MPPT circuitry 204 which automatically adjusts its input impedance to ensure that flexible PV module 202 operates at its maximum power point. The output of the MPPT circuitry 204 is electrically coupled to the charge control circuitry 206 which monitors the voltage of the battery subsystem 210. Possible functions of the charge control circuitry 206 include (1) determining the charge state of the battery subsystem 210, (2) routing power from the flexible photovoltaic module 202 to the battery subsystem 210 to safely charge the battery subsystem 210 if it is not sufficiently charged, (3) terminating charging of the battery subsystem 210 when it has reached its maximum capacity, and/or (4) routing power from the flexible photovoltaic module 202, that is not associated with charging of the battery subsystem 210, to the load management circuitry 208. In addition, the charge control circuitry 206 may monitor the health of the battery subsystem 210, preventing the charging of batteries that are damaged or have exceeded their useful life. In some embodiments, the battery subsystem 210 includes one or more lithium ion (Li-Ion) batteries, lithium polymer (LiPo) batteries, zinc-air, or other battery chemistries.

Load management circuitry 208 converts power received from the charge control circuitry 206 and/or from the battery subsystem 210 into a stable, fixed DC power output on an internal bus voltage rail 212 for use by various power conversion options. The load management circuitry 208 also provides overcurrent protection on the internal bus voltage rail 212, in some embodiments. Low-power conversion circuitry 220 generates a low-power voltage rail 222 from the internal bus voltage rail 212, such as for charging portable electronic devices through one or more USB interfaces 224 electrically coupled to low-power voltage rail 222. In some embodiments, the USB interfaces support 1.x, 2.x and 3.x protocols. For example, in particular embodiments, the USB interfaces support the USB 3.1 standard, which supports up to a 100 watt load at a 5 ampere limit with voltages negotiated through the Power Delivery protocol upon connection. In addition, the type of connector can vary, provided that it supports the desired USB protocol. For portable power systems, the USB interface is necessary as it is the de facto battery charging interface for cell phones, MP3 players, tablets, and various other portable electronic devices.

High-power conversion circuitry 214 generates a high-power voltage rail 216 from the internal bus voltage rail 212. The voltage of high-power voltage rail 216 is user-selectable in some embodiments. High-power voltage rail 216 is electrically coupled to a high-power bus 236 in certain embodiments via protection circuitry 234. High-power voltage rail 216 is used, for example, to operate larger electronic devices, or even to chain to similar PV portable power systems in parallel through high-power bus 236. For example, in some embodiments, high-power conversion circuitry 214 is capable of generating high-power voltage rail 216 at a voltage of 24 VDC, such as for use by the military and first responders. Additionally, two or more instances of portable power system 200 could be electrically coupled in parallel via high-power bus 236, to power large loads.

Inverter 226 generates an AC output 228 from the internal bus voltage rail 212, such as for operating common household equipment. Inverter 226 is, for example, matched to the voltage and frequency of its intended load (e.g., 120 VAC at 60 hertz or 220 VAC at 50 hertz). In embodiments intended to power large AC loads, the flexible photovoltaic module 202, MPPT circuitry 204, charge control circuitry 206, load management circuitry 208, battery subsystem 210, and inverter 226 must be capable of supporting such load.

Low-power conversion circuitry 220, high-power conversion circuitry 214, and inverter 226 are each electrically coupled to one or more electrical connectors 218, 224 and 230 for interfacing with external circuitry. The electrical connectors include two leads providing positive and negative terminals (not numbered), respectively. In certain embodiments, the electrical connectors 218, 224, 230 are waterproof and capable of preventing moisture ingress into a case of the MSDN subsystem. The electrical connectors are optionally automotive-grade or military grade to promote reliability and long life. In a particular embodiment, one or more of the electrical connectors 218, 224, and 230 are magnetically-attached (type) connectors. In another embodiment (not shown), the means for transferring electrical power facilitated by the electrical connectors 218, 224, or 230, may be replaced by wireless power transmission, possibly through a close-proximity charging system or a microwave power beaming apparatus. The integrated networking solution 238 includes both an uplink to an available Internet portal and a local area network (LAN). The Internet portal can be, for example, a cellular 4G LTE link, a military-grade secure satellite link, a communication drone, a geostationary airship, and local access point. The ability to connect with this remote Internet portal can be made via an antenna 242 communicatively coupled to integrated networking solution 238. The LAN may consist of wired, optical fiber, or wireless Ethernet connections, where the wireless signal is affected by the antenna 240 communicatively coupled to integrated networking solution 238. Antennas 240 and 242 can be of various designs, but are matched to the intended RF or microwave frequency. The antennas 240 and 242 may also be a means for receiving optical data transmission as well. The integrated networking solution 238 may also contain various wired interfaces, such as traditional Ethernet connectors. In addition, the networking solution 238, often referred to as a ‘Hotspot’, can accommodate numerous users simultaneously in order to affect a high-quality network solution in outdoor and/or rugged environments. The networking solution 238 also optionally includes onboard security to prevent unwanted access or attack.

In some embodiments, MPPT circuitry 204, charge control circuitry 206, and load management circuitry 208 are integrated into a single component. High-power conversion circuitry 214, low-power conversion circuitry 220, inverter 226 and networking function 238 are also integrated into a single component in certain embodiments. The networking solution, or ‘Hotspot’ 238 may likewise utilize various voltages from the high-power circuitry 214, low-power conversion circuitry 220, or the inverter 226 as needed for various functions, as provided by a power distribution bus 232. Thus, integrated networking solution 238 is at least partially powered from flexible photovoltaic module 202. Furthermore, it should be appreciated that the number and configuration of devices electrically coupled to the internal bus voltage rail 212 may be varied without departing from the scope hereof. For example, one or more of high-power conversion circuitry 214, low-power conversion circuitry 220, and inverter 226 could be omitted with the networking function 238 intact. As another example, additional power conversion circuitry could be electrically coupled to internal bus voltage rail 212.

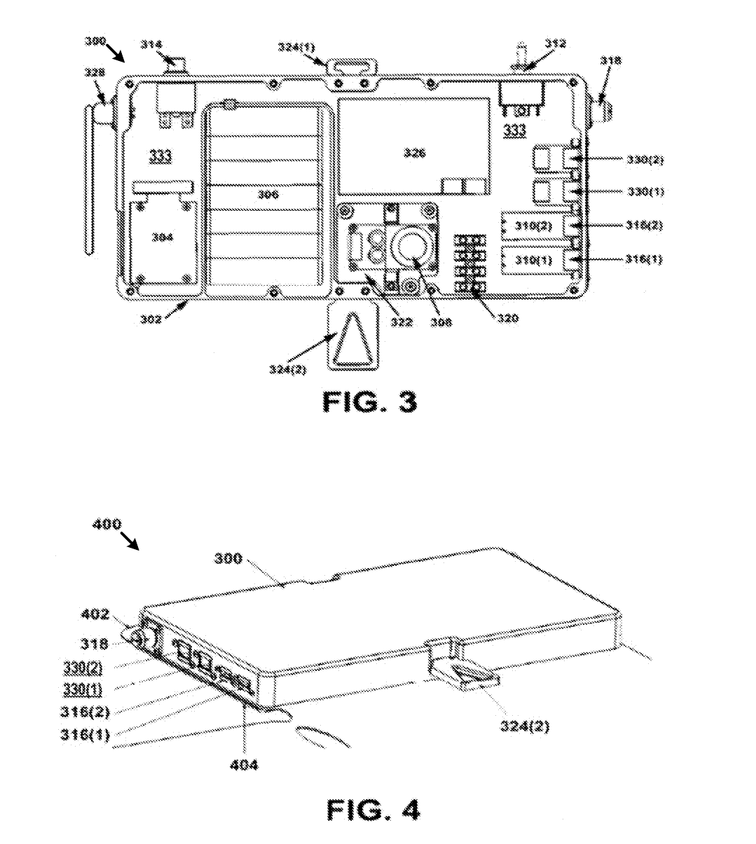

FIG. 3 is a top plan view of a MSDN subsystem 300, which is one possible embodiment of the MSDN subsystem of portable power system 200. Accordingly, the MSDN subsystem 300 includes maximum power point tracking (MPPT) circuitry 204, charge control circuitry 206, load management circuitry 208, a battery subsystem 210, high-power conversion circuitry 214, low-power conversion circuitry 220, an inverter 226, integrated networking solution 238, and protection circuitry 234 co-packaged in a common case 302. In some embodiments, the case 302 is rigid, impervious to moisture, capable of minimizing ingress of water into the case through openings, and/or a ruggedized case capable of withstanding significant impact and physical abuse. The case 302 is, for example, formed of lightweight, non-metallic material, which in some embodiments, is formed by machining, molding, or 3-D printing. In some embodiments, case 302 may consist of multiple parts in order to minimize ingress of water into the case. Furthermore, the case 302 has an opening, which interfaces with a flap 402 of the flexible photovoltaic module 202, as discussed below with respect to FIGS. 4-7.

The functions of MPPT circuitry 204, charge control circuitry 206, and load management circuitry 208 are combined into an MPPT system board 304 in MSDN subsystem 300. MPPT system board 304 is matched to the voltage and chemistry of a lightweight battery subsystem 306, which implements battery subsystem 210. The MPPT 304 contains a load output that is matched to the input voltage required by the network system 326, the high-power regulator board 308 and the low-power USB regulator boards 310, which respectively implement high-power conversion circuitry 214 and low-power oted as (B14) through (B16) may further include at least one electrical connector electrically cally coupled to at least one of the low-power voltage rail and the high-power voltage rail. rated specifications. In some embodiments, protection circuitry 234 is further implemented via at least one fuse (not shown) triggered by excessive current magnitude. To achieve moisture ingress protection, the disconnect switch 312, circuit breaker 314, and fuse holders (if applicable) are typically waterproof, and in some embodiments, these components are rugged and/or meet automotive or military specifications. In an alternate embodiment, the (mechanical) disconnect switch 312 is replaced with, or supplemented by, a magnetically-keyed disconnect switch activated through case 302, or a wirelessly operated disconnect switch, for disconnecting MSDN subsystem 300 from external circuitry.

To provide electrical power to a user, waterproof USB connectors 316 are electrically coupled to outputs of respective low-power USB regulator boards 310, and a high-power waterproof connector 318 is electrically coupled to an output of high-power regulator board 308. Disconnect switch 312 and circuit breaker 314 provides isolation from high-power bus 236. Connector 318 is military grade in some embodiments to be certifiable in such applications. MSDN subsystem 300 further includes a terminal strip 320 that provides the function of power distribution bus 236 for connection points among the various power connections within MSDN subsystem 300. In some embodiments, terminal strip 320 includes, but not limited to, connections to the output bus voltage from MPPT system board 304, the high-power bus 216, as well as the networking board 326 representing the integrated networking solution 238.

The networking board 326 includes both a wireless (WiFi) connectivity and wired Ethernet connections. To provide access to the wired Ethernet connectors, Ethernet connectors 330 are electrically coupled to outputs of Ethernet ports (not numbered) of the networking board 326. In some embodiments, the Ethernet connectors 330 are waterproof or military grade. The wireless connections for the cellular and Ethernet signals are facilitated by antennas. In one embodiment, the an antenna 328 is matched to the frequency required for the cellular signal, and the antennas for the WiFi signal can be planar ‘patch’ antennas (not shown) that are either bonded to the case 302, such as to an inside surface of case 302, or embedded in the flexible photovoltaic module 202 i.e. PV Blanket. In other embodiments, all antennas are of traditional construction, attached to the case 302, and are folded and/or rotated into a stowed configuration when not in use.

MSDN subsystem 300 optionally further includes a heat spreader 322 thermally coupled to high-power regulator board 308 to transfer heat away from the regulator board. Use of heat spreader 322 may be desired, for example, in embodiments where thermal conductivity of case 302 is insufficient to adequately cool high-power regulator board 308. Heat spreader 322 is typically formed of a material that has a high thermal conductivity and is lightweight, such as aluminum, copper, or carbon-carbon composite materials.

MSDN subsystem 300 further includes at least one strap connector 324 disposed on an exterior of case 302. As further discussed below, strap connectors 324 are capable of at least partially securing a flexible photovoltaic module to MSDN subsystem 300, when the flexible photovoltaic module is placed in a folded position for stowing.

The case 302 is optionally potted to protect circuitry and wiring therein from damage from moisture, dirt, and vibration. In some embodiments, the case 302 also provides a rugged mounting point (not numbered) for various accessories.

FIGS. 4-7 each show a different perspective view of a photovoltaic-based fully integrated portable power system 400, which is an embodiment of portable power system 200 (FIG. 2). The portable power system 400 includes an instance of the MSDN subsystem 300 attached to the flexible photovoltaic module 402 implementing the flexible photovoltaic module 202, such that MSDN subsystem 300 is mechanically and electrically coupled to flexible photovoltaic module 402. Specifically, a portion of the flexible photovoltaic module 402 is disposed on an opening 333 (not visible in FIGS. 4-7) in case 302 of MSDN subsystem 300, and a mounting plate 404 is disposed on the flap 402 flexible photovoltaic module 202 over opening 333, such that a portion of the flap 402 of the flexible photovoltaic module 202 is sandwiched between the MSDN subsystem 300 and the mounting plate 404. Dimensions of the mounting plate 404 may exceed that of the case 302 in order to add necessary stiffness to protect from damage during repeated deployment and stowage operations, but ideally will not exceed the width of the portion of the flap 402 of the flexible photovoltaic module 202, e.g., the PV blanket segment upon which assembly 300 is mounted. Fastening devices, such as screws, bolts, or rivets, secure the mounting plate 404 to MSDN subsystem 300.

The flap 402 of the flexible photovoltaic module 202 includes electrical terminals (not numbered) electrically coupled to MSDN subsystem 300. The electrical terminals are covered by MSDN subsystem 300, and in some embodiments, the electrical terminals are further covered by the mounting plate 404, to help prevent accidental contact to the electrical terminals and to protect the electrical terminals from possible impact damage. The flap 402 of the flexible photovoltaic module 202 is capable of being disposed in at least an unfolded position for deployment and in a folded position for stowing. The strap connectors 324 are capable of securing flexible photovoltaic module 402 to the MSDN subsystem 300 when the flexible photovoltaic module 402 is disposed in its folded position.

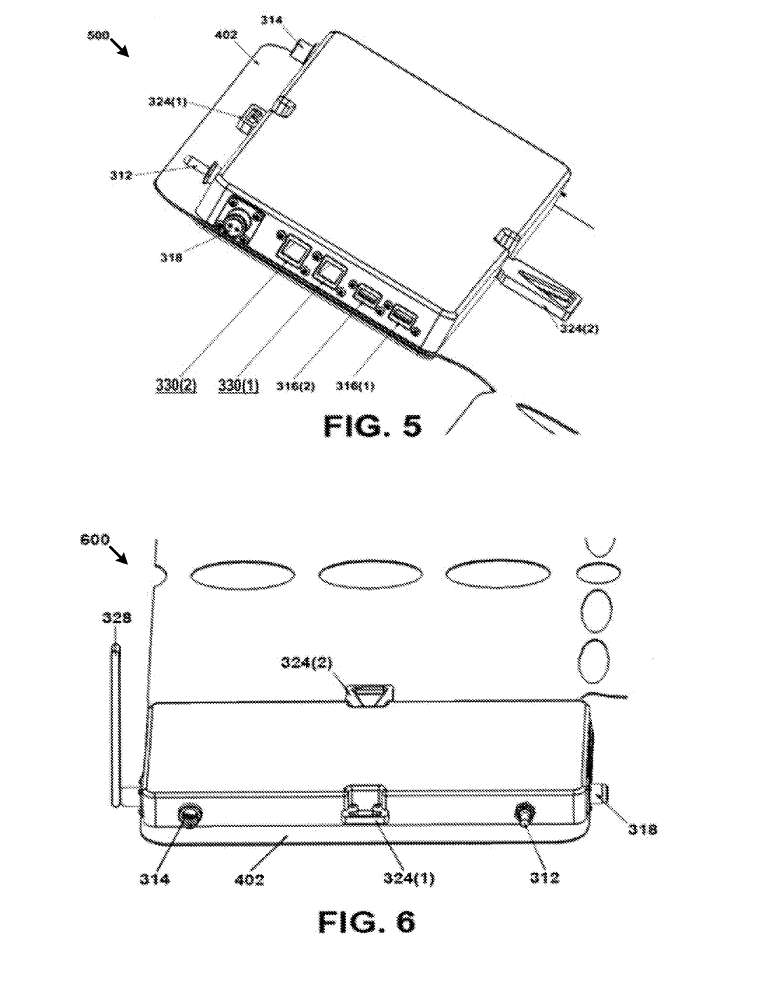

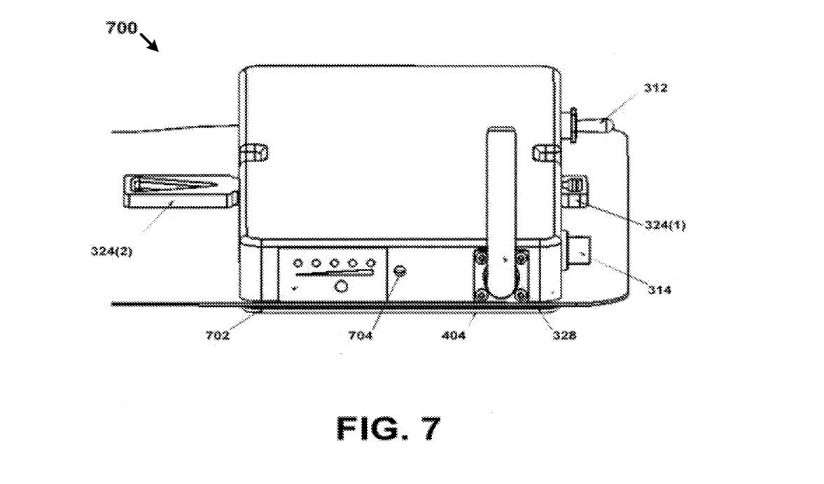

USB connectors 316, high-power connector 318, Ethernet connectors 330, and strap connector 324(2) are visible in the FIG. 4 perspective view. The disconnect switch 312, circuit breaker 314, and strap connector 324(1) are further visible in the FIG. 5 perspective view, and the antenna 328 are visible in the FIG. 6 perspective view. A battery status display 702 and an indicator 704 are additionally visible in the perspective view of FIG. 7. Battery status display 702 alerts a user as to the charge state of battery subsystem 306. Although battery status display 702 is illustrated as being implemented by a plurality of light emitting diodes (LEDs), the battery status display may alternately be implemented by an electromechanical meter or a digital display. The indicator 704 alerts a user as to the MPPT 204 status of MSDN 300, such as MPPT 204 performance, including whether the battery is being charged, if the battery system 210 is faulty, or if the output of the load management circuitry 208 (e.g. electrical load) is excessive. In some embodiments, indicator 704 also alerts a user if the flexible PV module 402 has sunlight available to it and disconnect switch 312 has disabled the system (e.g. battery subsystem 306 is not charging). When portable power system 400 is inverted so that the light sensitive side of the flexible PV module 402 is facing towards the sun, the USB connectors 316, high-power connectors 318, disconnect switch 312, and circuit breaker 314 are still accessible from the side.

Combinations of Features

Features described above as well as those claimed below may be combined in various ways without departing from the scope hereof. The following examples illustrate some possible combinations:

(A1) A photovoltaic-based fully integrated portable power system may include (1) an integrated power management, storage, and distribution and networking (MSDN) subsystem including a case having an opening, (2) a flexible photovoltaic module capable of being disposed in at least a folded position and an unfolded position, a portion of the flexible photovoltaic module being disposed over the opening of the case, and (3) a mounting plate disposed on the flexible photovoltaic module and over the opening of the case, such that the portion of the flexible photovoltaic module is sandwiched between the MSDN subsystem and the mounting plate.

(A2) In the system denoted as (A1), the MSDN subsystem may include at least one strap connector for securing the flexible photovoltaic module to the MSDN subsystem when the flexible photovoltaic module is disposed in the folded position.

(A3) In either of the systems denoted as (A1) or (A2), the flexible photovoltaic module may include at least one flexible thin-film photovoltaic device selected from the group consisting of a copper-indium-gallium-selenide (CIGS) photovoltaic device, a copper-indium-gallium-sulfur-selenide (CIGSSe) photovoltaic device, a copper zinc tin sulfide (CZTS) photovoltaic device, a cadmium-telluride (CdTe) photovoltaic device, a silicon (Si) photovoltaic device, and an amorphous silicon (a-Si) photovoltaic device.

(A4) In either of the systems denoted as (A1) or (A2), the flexible photovoltaic module may include at least one flexible crystalline photovoltaic device selected from the group consisting of a thin crystalline silicon (Si) photovoltaic device and a thin gallium arsenide (GaAs) photovoltaic device.

(A5) In the system denoted as (A4), the at least one flexible crystalline photovoltaic device may be fabricated by epitaxial lift-off (ELO) or by mechanical thinning of crystalline wafers.

(A6) In any of the systems denoted as (A1) through (A5), the flexible photovoltaic module may include electrical terminals covered by at least the MSDN subsystem.

(A7) In any of the systems denoted as (A1) through (A6), the MSDN subsystem may include a ruggedized case for providing protection from physical and environmental attack, as well as mechanical mounting points for internal circuitry and through access for electrical connectors and indicators.

(A8) In any of the systems denoted as (A1) through (A7), the mounting plate may extend beyond the area covered by the ruggedized case.

(A9) In any of the systems denoted as (A1) through (A8), the MSDN subsystem may include: (1) maximum power point tracking circuitry for causing the flexible photovoltaic module to operate at its maximum power point, (2) charge control circuitry for controlling charging of a battery subsystem, (3) load management circuitry for generating an internal bus voltage rail and for providing overcurrent protection, (4) low-power conversion circuitry for generating a low-power voltage rail from the internal bus voltage rail, (5) high-power conversion circuitry for generating a high-power voltage rail from the internal bus voltage rail, (6) protection circuitry for interrupting operation of the MSDN subsystem and disconnecting the MSDN subsystem from external circuitry, and (7) Internet networking system for providing both a link to a remote source for Internet connection, as well as a wired and wireless Ethernet connection for devices to the system.

(A10) In the system denoted as (A9), the MSDN subsystem may further include an inverter.

(A11) In either of the systems denoted as (A9) or (A10), the MSDN subsystem may further include the battery subsystem, the battery subsystem including a battery selected from the group consisting of a lithium ion (Lion) battery, a lithium polymer (LiPo) battery, and a zinc-air battery.

(A12) Any of the systems denoted as (A9) through (A11) may further include at least one electrical connector for interfacing with external circuitry.

(A13) In the system denoted as (A12), the at least one electrical connector may include an USB interface with 1.x, 2.x and 3.x protocols.

(A14) In either of the systems denoted as (A12) or (A13), the at least one electrical connector may be waterproof.

(A15) In any of the systems denoted as (A12) through (A14) the at least one electrical connector may be capable of preventing moisture ingress into the case of the MSDN subsystem.

(A16) In any of the systems denoted as (A12) through (A15), the at least one electrical connector may be an automotive-grade connector.

(A17) In any of the systems denoted as (A12) through (A16), the at least one electrical connector may be a threaded military-grade connector.

(A18) In any of the systems denoted as (A12) through (A17), the at least one electrical connector may include two leads providing high-power positive and negative terminals, respectively.

(A19) In any of the systems denoted as (A12) through (A18), the at least one electrical connector may include first and second electrical connectors electrically coupled in parallel, for providing an internal bypass for stringing multiple systems together to increase power capacity.

(A20) In any of the systems denoted as (A12) through (A19), the at least one electrical connector may include a magnetically-attached connector.

(A21) In any of the systems denoted as (A12) through (A20), the at least one electrical connector may include a wireless power transmission mechanism, including close proximity charging and microwave power beaming capability.

(A22) In any of the systems denoted as (A9) through (A21), the protection circuitry may include at least one fuse triggered by excessive current magnitude.

(A23) In the system denoted as (A22), the MSDN subsystem may include a fuse holder for housing the at least one fuse, the fuse holder capable of preventing moisture ingress into the case of the MSDN subsystem.

(A24) In any of the systems denoted as (A9) through (A23), the protection circuitry may include a user-resettable circuit breaker triggered by excessive current magnitude.

(A25) In the system denoted as (A24), the user-resettable circuit breaker may be capable of preventing moisture ingress into the case of the MSDN subsystem.

(A26) In any of the systems denoted as (A9) through (A25), the protection circuitry may include a mechanical disconnect switch for disconnecting the MSDN subsystem from external circuitry.

(A27) In the system denoted as (A26), the mechanical disconnect switch may be capable of preventing moisture ingress into the case of the MSDN subsystem.

(A28) In any of the systems denoted as (A9) through (A27), the protection circuitry may include a magnetically-keyed switch activated through the case of the MSDN subsystem, for disconnecting the MSDN subsystem from external circuitry.

(A29) In any of the systems denoted as (A9) through (A28), the protection circuitry may include a wirelessly operated disconnect switch, for disconnecting the MSDN subsystem from external circuitry.

(A30) In any of the systems denoted as (A9) through (A29), the Internet networking system may include onboard security to prevent unwanted access or attack.

(A31) In any of the systems denoted as (A9) through (A30), the Internet networking system may include a cellular-based connection to the Internet.

(A32) In any of the systems denoted as (A9) through (A31), the Internet networking system may include a secure military-grade connection to a local access point, orbital satellite network, communication drones, geostationary airships, or other means of secure networking.

(A33) In any of the systems denoted as (A9) through (A32), the Internet networking system may include a wired networking connection accessible outside the case.

(A34) In any of the systems denoted as (A9) through (A33), the Internet networking system may include a wireless networking interface accessible outside the case.

(A35) In any of the systems denoted as (A9) through (A34), the Internet networking system may include a fiber optic connection interface accessible outside the case.

(B1) A photovoltaic-based fully integrated portable power management and networking system may include (1) a flexible photovoltaic module capable of being disposed in at least a folded position and an unfolded position, and (2) an integrated power management, storage, and distribution and networking (MSDN) subsystem mechanically and electrically coupled to the flexible photovoltaic module, the MSDN subsystem including an integrated networking subsystem for providing Internet connection to one or more devices, the integrated networking subsystem at least partially powered from the flexible photovoltaic module.

(B2) In the system denoted as (B1), the integrated networking subsystem may be configured to provide at least one of a wired Ethernet Internet connection, a wireless Ethernet Internet connection, and an optical Ethernet Internet connection, to the one or more devices.

(B3) In the system denoted as (B2), the integrated networking subsystem may be configured to provide at least the wireless Internet connection, and the MSDN subsystem may further include an antenna communicatively coupled to the integrated networking subsystem to at least partially establish the wireless Ethernet Internet connection.

(B4) In the system denoted as (B3), the antenna may be integrated into the flexible photovoltaic module, or the antenna may be bonded to a surface of the MSDN subsystem, such as to an inside surface of the MSDN subsystem.

(B5) In any of the systems denoted as (B1) through (B4), the integrated networking subsystem may be configured to establish an Internet uplink via at least one of a cellular communication network, a satellite communication network, a communication drone, a geostationary airship, and a local access point.

(B6) In the system denoted as (B5), the MSDN subsystem may further include an additional antenna communicatively coupled to the integrated networking subsystem to at least partially establish the Internet uplink.

(B7) In any of the systems denoted as (B1) through (B6), the integrated networking subsystem may include onboard security to prevent unwanted access.

(B8) In any of the systems denoted as (B1) through (B7), the MSDN subsystem may further include a case, with the integrated networking subsystem disposed within the case and the at least one of the wired Ethernet Internet connection, the wireless Ethernet Internet connection, and the optical Ethernet connection being accessible outside of the case.

(B9) In the system denoted as (B8), the MSDN subsystem may further including a fiber optic connection interface accessible outside of the case, where the fiber optic connection interface is communicatively coupled with the integrated networking subsystem for providing the optical Ethernet Internet connection.

(B10) In either of systems denoted as (B8) or (B9), the case may have an opening, a portion of the flexible photovoltaic module may be disposed over an opening in the case, and the system may further include a mounting plate disposed on the flexible photovoltaic module and over the opening of the case, such that the portion of the flexible photovoltaic module is sandwiched between the MSDN subsystem and the mounting plate.

(B11) In the system denoted as (B10), the mounting plate may extend beyond the MSDN subsystem.

(B12) In any of the systems denoted as (B8) through (B11), the MSDN subsystem may further include at least one strap connector for securing the flexible photovoltaic module to the MSDN subsystem when the flexible photovoltaic module is disposed in the folded position.

(B13) In any of the systems denoted as (B8) through (B12), the flexible photovoltaic module may include electrical terminals covered by at least the MSDN subsystem.

(B14) In any of the systems denoted as (B1) through (B13), the MSDN subsystem may further include: (1) maximum power point tracking circuitry for causing the flexible photovoltaic module to operate at its maximum power point, (2) charge control circuitry for controlling charging of a battery subsystem, (3) load management circuitry for generating an internal bus voltage rail and for providing overcurrent protection, (4) low-power conversion circuitry for generating a low-power voltage rail from the internal bus voltage rail, (5) high-power conversion circuitry for generating a high-power voltage rail from the internal bus voltage rail, (6) protection circuitry for interrupting operation of the MSDN subsystem and disconnecting the MSDN subsystem from external circuitry, and (7) a distribution bus for powering the integrated networking subsystem from at least one of the low-power voltage rail and the high-power voltage rail.

(B15) The system denoted as (B14) may further include an inverter.

(B16) In either of the systems denoted as (B14) or (B15), the battery subsystem may include a battery selected from the group consisting of a lithium ion (Lion) battery, a lithium polymer (LiPo) battery, and a zinc-air battery.

(B17) Any of the systems denoted as (B14) through (B16) may further include at least one electrical connector electrically coupled to at least one of the low-power voltage rail and the high-power voltage rail.

(B18) In the system denoted as (B17), the at least one electrical connector may include a USB connector.

(B19) In any of the systems denoted as (B1) through (B18), the flexible photovoltaic module may include at least one flexible thin-film photovoltaic device selected from the group consisting of a copper-indium-gallium-selenide (CIGS) photovoltaic device, a copper-indium-gallium-sulfur-selenide (CIGSSe) photovoltaic device, a copper zinc tin sulfide (CZTS) photovoltaic device, a cadmium-telluride (CdTe) photovoltaic device, a silicon (Si) photovoltaic device, and an amorphous silicon (a-Si) photovoltaic device.

(B20) In any of the systems denoted as (B1) through (B18), the flexible photovoltaic module comprising at least one flexible crystalline photovoltaic device selected from the group consisting of a thin crystalline silicon (Si) photovoltaic device and a thin gallium arsenide (GaAs) photovoltaic device.

Changes may be made in the above apparatus, systems and methods without departing from the scope hereof, and therefore, it is intended that all matter contained in the above description or shown in the accompanying drawings be interpreted as illustrative and not in a limiting sense. It is also to be understood that the following claims are to cover certain generic and specific features described herein.

What is claimed is:

1. A photovoltaic-based fully integrated portable power management and networking system, comprising:
a flexible photovoltaic module capable of being disposed in at least a folded position and an unfolded position; and
an integrated power management, storage, and distribution and networking (MSDN) subsystem mechanically and electrically coupled to the flexible photovoltaic module, the MSDN subsystem including an integrated networking subsystem for providing Internet connection to one or more devices, the integrated networking subsystem at least partially powered from the flexible photovoltaic module.

2. The system of claim 1, the integrated networking subsystem being configured to provide at least one of a wired Ethernet Internet connection, a wireless Ethernet Internet connection, and an optical Ethernet Internet connection, to the one or more devices.

3. The system of claim 2, the integrated networking subsystem being configured to establish an Internet uplink via at least one of a cellular communication network, a satellite communication network, a communication drone, a geostationary airship, and a local access point.

4. The system of claim 3, the MSDN subsystem further including a first antenna communicatively coupled to the integrated networking subsystem to at least partially establish the Internet uplink.

5. The system of claim 4, the integrated networking subsystem being configured to provide at least the wireless Ethernet Internet connection, the MSDN subsystem further including a second antenna communicatively coupled to the integrated networking subsystem to at least partially establish the wireless Ethernet Internet connection.

6. The system of claim 5, the second antenna being integrated into the flexible photovoltaic module or bonded to a surface of the MSDN subsystem.

7. The system of claim 3, the integrated networking subsystem including onboard security to prevent unwanted access.

8. The system of claim 3, the MSDN subsystem further including a case, the integrated networking subsystem being disposed within the case, the at least one of the wired Ethernet Internet connection, the wireless Ethernet Internet connection, and the optical Ethernet Internet connection being accessible outside of the case.

9. The system of claim 8, the MSDN subsystem further including a fiber optic connection interface accessible outside of the case, the fiber optic connection interface being communicatively coupled with the integrated networking subsystem for providing the optical Ethernet Internet connection.

10. The system of claim 3, the MSDN subsystem further including:
maximum power point tracking circuitry for causing the flexible photovoltaic module to operate at its maximum power point;
charge control circuitry for controlling charging of a battery subsystem;
load management circuitry for generating an internal bus voltage rail and for providing overcurrent protection;
low-power conversion circuitry for generating a low-power voltage rail from the internal bus voltage rail;
high-power conversion circuitry for generating a high-power voltage rail from the internal bus voltage rail;
protection circuitry for interrupting operation of the MSDN subsystem and disconnecting the MSDN subsystem from external circuitry; and
a distribution bus for powering the integrated networking subsystem from at least one of the low-power voltage rail and the high-power voltage rail.

11. The system of claim 10, the MSDN subsystem further including an inverter.

12. The system of claim 10, the battery subsystem including a battery selected from the group consisting of a lithium ion (Lion) battery, a lithium polymer (LiPo) battery, and a zinc-air battery.

13. The system of claim 10, further comprising at least one electrical connector electrically coupled to at least one of the low-power voltage rail and the high-power voltage rail.

14. The system of claim 13, the at least one electrical connector comprising a USB connector.

15. The system of claim 8, wherein:
the case has an opening;
a portion of the flexible photovoltaic module is disposed over an opening in the case; and
the system further comprises a mounting plate disposed on the flexible photovoltaic module and over the opening of the case, such that the portion of the flexible photovoltaic module is sandwiched between the MSDN subsystem and the mounting plate.

16. The system of claim 15, the MSDN subsystem further including at least one strap connector for securing the flexible photovoltaic module to the MSDN subsystem when the flexible photovoltaic module is disposed in the folded position.

17. The system of claim 15, the flexible photovoltaic module including electrical terminals covered by at least the MSDN subsystem.

18. The system of claim 15, the mounting plate extending beyond the MSDN subsystem.

19. The system of claim 1, the flexible photovoltaic module comprising at least one flexible thin-film photovoltaic device selected from the group consisting of a copper-indium-gallium-selenide (CIGS) photovoltaic device, a copper-indium-gallium-sulfur-selenide (CIGSSe) photovoltaic device, a copper zinc tin sulfide (CZTS) photovoltaic device, a cadmium-telluride (CdTe) photovoltaic device, a silicon (Si) photovoltaic device, and an amorphous silicon (a-Si) photovoltaic device.

20. The system of claim 1, the flexible photovoltaic module comprising at least one flexible crystalline photovoltaic device selected from the group consisting of a thin crystalline silicon (Si) photovoltaic device and a thin gallium arsenide (GaAs) photovoltaic device.
